(19) United States
(12) Patent Application Publication
(10) Pub. No.: US 2006/0277053 A1
(43) Pub. Date: Dec. 7, 2006

(54) Automated communication for financial information

(76) Inventors: Michael Lobb, Twickenham (GB); Jonathan Hogg, London (GB)

Correspondence Address: SUGHRUE MION, PLLC, 2100 PENNSYLVANIA AVENUE, N.W., SUITE 800, WASHINGTON, DC, 20037, US

(21) Appl. No.: 10/563,874

(22) PCT Filed: Jul. 1, 2004
(86) PCT No.: PCT/GB04/02846

§ 371 Date: Jun. 19, 2006

(30) Foreign Application Priority Data
Jul. 9, 2003 (GB) 0316079.3

(51) Int. Cl. G06Q 99/00

(52) U.S. Cl. 705/1

(57) ABSTRACT

There is described a technique for workflow preparation utilising instant messaging, implemented in a computer network. The workflow may be a financial report. The instant messaging notifies of the completion of various stages in the workflow.

### FIELD OF THE INVENTION

The present invention relates to a method of processing a workflow, and particularly but not exclusively to the provision and accessing of reports, such as financial reports, using computer networking technologies.

### BACKGROUND OF THE INVENTION

In equities research, analysts working for financial organizations prepare reports for the organizations clients, which information is used by the clients to make decisions as to the purchase of equities.

The preparation of such reports involves a number of processes. A report prepared by an analyst is provided to an editor for proof reading and to ensure consistency with a house style, for example, and is provided to a compliance officer to ensure consistency with financial regulations. After each stage, the report may be returned to the analyst to ensure the intended content of the report is maintained.

This procedure is one which inherently involves time delays due to the need to transfer the report between the various parties. The availability of certain parties may be limited, and after a particular part of the process is complete there may be a delay before the next person receives the report, or is aware of the report awaiting their input.

Contrary to this process, the publication of the reports is time critical. If there is a delay in publishing the report, even of only a matter of minutes, then the information in the report may become redundant. Alternatively, a similar report may have been published earlier by a competing organization. There is therefore a general desire in the art to publish such reports without delay.

There is a technical problem that exists, at least in part associated with the mechanisms for preparing the report pre-publication. Typically the transmission of the report between the various parties will be by e-mail. There may be a delay in any party reading their e-mail and thus becoming aware of the existence of a need to provide input.

Further the actual publication of reports has historically been by means of printing and posting, and more recently by posting on websites with e-mail notification to interested parties, or direct transmission by e-mail.

Different types of reports have different priorities for the time constraints in being sent to clients. For example short research notes can be compiled more quickly than long-range research reports, and consequently there is an associated necessity to deliver such research notes to clients without delay.

Current technology, the most advanced of which uses e-mail to distribute reports both in the preparation and publication stage, is associated with inherent delays.

In general, such problems reflect a general technological problem in the area of workflows.

Thus current technology for the compilation and distribution of such reports does not provide a satisfactory technological infrastructure.

It is an object of the present invention to provide an improved technique which addresses one or more of the above-stated problems.

### SUMMARY OF THE INVENTION

In one aspect the invention provides a method of monitoring a database, comprising notifying a database subscriber by instant messaging when an entry in the database is altered.

A database entry may be altered by addition of a new database entry, or by amendment of an existing database entry, or by deletion of an existing database entry.

The database may be an auction database, said subscriber being an auction bidder, and said alteration of a database entry being the addition to an auction of an item of interest to the auction bidder.

Said database may be an electronic games database comprising a plurality of entries associated with a game, said subscriber being a player of said game, and said alteration of a database entry being an action in said game which affects the player. The game may be a character-based game, said player being associated with a character in the game, the action being an occurrence associated with said character. The game may be an on-line interactive game.

The method may further comprise the step of determining whether the subscriber is present to receive said message. If the subscriber is not present, a nominated delegate may be notified by instant messaging.

The method may further comprise the step of determining the presence of the delegate, wherein the delegate is notified if present.

In this aspect, there may be provided means adapted to store a database associated with the method. In this aspect, there may further be provided a computer system having means adapted to perform the method steps.

In another aspect the invention provides a computer system adapted for monitoring a database, comprising means for notifying a database subscriber by instant messaging when an entry in the database is altered.

The computer system may comprise means for altering a database entry by addition of a new database entry, or means for altering a database entry by amendment of an existing database entry, or means for altering a database entry by deletion of an existing database entry.

Said database may be an auction database, said subscriber being an auction bidder, wherein the computer system comprises means for alteration of a database entry by the addition to an auction of an item of interest to the auction bidder.

Said database may be an electronic games database comprising a plurality of entries associated with a game, said subscriber being a player of said game, wherein the computer system comprises means for alteration of a database entry based on an action in said game which affects the player. The game may be a character-based game, said player being associated with a character in the game, the action being an occurrence associated with said character. Said game may be an on-line interactive game.

The computer system may further comprise presence means for determining whether the subscriber is present to receive said message.

The computer system may further comprise means, responsive to the subscriber not being present, for notifying a nominated delegate by instant messaging.

The computer system may further comprise means for determining the presence of the delegate, and means for notifying the delegate if present.

In a further aspect the invention provides a method of processing a workflow comprising a plurality of tasks, in which completion of at least one task is notified by instant messaging.

The notification may be to an owner of a subsequent task. The method may further comprise storing an identity associated with said workflow in a database.

Said database may store the identity of a plurality of workflows.

The method may further comprise the step of storing a status associated with the current state of the workflow.

The status may be updated responsive to the notification by instant messaging of a task associated with the workflow. The updating of the status may be notified by instant messaging.

Completion of at least one task may be notified by a plurality of messages utilising instant messaging.

There is associated a plurality of users with said workflow, each message being associated with one of said users.

Each task may be completed by one of said users.

At least one task may be determined by a user.

At least one task may be the preparation of a document, and at least one further task may be preparation of a comment on a document.

The workflow may comprise the preparation of a report.

The method may further comprise determining the presence of a recipient of said instant messaging.

Said recipient may not be present, the instant messaging then being directed to a nominated delegate.

In a further aspect the invention provides a computer system adapted to process a workflow comprising a plurality of tasks, in which completion of at least one task is notified by instant messaging.

The computer system may include means adapted to notify an owner of a subsequent task.

The computer system may include means for storing an identity associated with said workflow in a database.

Said database may be adapted to store the identity of a plurality of workflows.

The computer system may include means for storing a status associated with the current state of the workflow.

The computer system may include means adapted to update the status responsive to the notification by instant messaging of a task associated with the workflow.

The computer system may include means for notifying updating of the status by instant messaging.

The computer system may include means for, responsive to completion of at least one task, for transmitting a plurality of messages utilising instant messaging.

There may be associated a plurality of users with said workflow, each message being associated with one of said users.

Each task may be completed by one of said users.

At least one task may be determined by a user.

At least one task may be the preparation of a document, and at least one further task may be preparation of a comment on a document.

The workflow may be the preparation of a report.

The computer system may further comprise means for determining the presence of a recipient of said instant messaging.

If said recipient is not present, the means may be adapted to direct instant messaging to a nominated delegate.

In a still further aspect the invention provides a method of compiling a financial report, comprising the steps of: preparing a report; notifying preparation of the report by instant messaging; responsive to said instant messaging notification, editing the report; notifying editing of the report by instant messaging; responsive to said instant messaging notification, checking the report for regulatory compliance; notifying completion of the check for compliance by instant messaging; and responsive to said instant messaging notification the report is completed.

There may further be provided a step of storing attributes of the report.

There may be provided a reports database comprising a plurality of entries each corresponding to one of a plurality of reports, each entry including the attributes for the respective report.

The attributes may include a current status of the report.

The attributes may include an identifier representing the author of the report.

The attributes may include at least one identifier representing subject-matter associated with the report.

The attributes may include a unique identifier for the report.

The method may further comprise the step of repeating the preparing step after the editing step.

The method may further comprise the step of repeating the preparing step after the compliance step.

The method may further comprise the step of repeating the editing step after the compliance step.

Responsive to completion of the report the report may be published.

The report may be published by instant messaging notification.

Said publication may be within a defined group.

Publication may be to a subscriber list.

The subscriber list may be stored in a subscriber database.

The subscriber database may store a record for each subscriber.

The record may comprise the subscriber identity and one or more attributes associated with the subscriber.

Said one or more attributes may include subject-matter of interest to the subscriber.

Said one or more attributes may include report authors of interest to the subscriber.

The publication of the report to a subscriber may be dependent upon the report being associated with one or more attributes of the said subscriber.

Responsive to the instant messaging notification, the report may be reviewed by one or more subscribers.

Responsive to the instant messaging notification, the report may be accessed by one or more subscribers.

The method may further comprise the step of requesting a financial transaction associated with the report.

Said request may be by instant messaging.

The instant message may be received by a broker associated with the report author.

The method may further comprise the step of any one of the plurality of subscribers commenting on the report, wherein the comments are notified to at least some of the subscribers by instant messaging.

The status of the report may be stored in a database.

The instant messaging notification may utilize presence services.

The report attributes may include a comment made by a report reviewer.

The publication of the report to a subscriber may be dependent on the report record including a comment from a predetermined report reviewer.

The attributes may comprise a plurality of said comments from a plurality of reviewers.

A comment may be entered into the report record responsive to an instant messaging notification from the reviewer.

The attributes may include a quality rating provided by a report reviewer.

The publication of the report to a subscriber may be dependent on the report record including a predetermined quality rating.

At least one of said instant messaging steps may include the step of establishing the presence of the recipient of said message. If the intended recipient is not present, the presence of a nominated delegate may be established and the instant messaging notification made to the delegate.

A notification to the delegate may be the original message.

A notification to the delegate may be that the intended recipient is not present. The notification to the delegate may be made after an elapsed time.

In a still further aspect the invention provides a computer system adapted for compiling a financial report, comprising: means for notifying preparation of the report by instant messaging; means for notifying editing of the report by instant messaging; and means for notifying completion of the check for compliance by instant messaging.

There may be further provided means for storing attributes of the report.

There may be provided a reports database comprising a plurality of entries each corresponding to one of a plurality of reports, each entry including the attributes for the respective report.

The attributes may include a current status of the report.

The attributes may include an identifier representing the author of the report.

The attributes may include at least one identifier representing subject-matter associated with the report.

The attributes may include a unique identifier for the report.

The computer system may further comprise means for publishing the report. The computer system may comprise means adapted to publish the report by instant messaging notification.

Publication may be to a subscriber list.

The subscriber list may be stored in a subscriber database.

The subscriber database may store a record for each subscriber.

The record may comprise the subscriber identity and one or more attributes associated with the subscriber.

Said one or more attributes may include subject-matter of interest to the subscriber.

Said one or more attributes may include report authors of interest to the subscriber.

The publication of the report to a subscriber may be dependent upon the report being associated with one or more attributes of the said subscriber.

A method according to claim 101 wherein responsive to the instant messaging notification, the report is reviewed by one or more subscribers.

Responsive to the instant messaging notification, the report may be accessed by one or more subscribers.

The method may further comprise the step of requesting a financial transaction associated with the report. Said request may be by instant messaging. The instant message may be received by a broker associated with the report author.

The method may further comprise the step of any one of the plurality of subscribers commenting on the report, wherein the comments are notified to at least some of the subscribers by instant messaging.

The status of the report may be stored in a database.

The instant messaging notification may utilize presence services.

The report attributes may include a comment made by a report reviewer.

The publication of the report to a subscriber may be dependent on the report record including a comment from a predetermined report reviewer.

The attributes may comprise a plurality of said comments from a plurality of reviewers.

A comment may be entered into the report record responsive to an instant messaging notification from the reviewer.

The attributes may include a quality rating provided by a report reviewer.

The publication of the report to a subscriber may be dependent on the report record including a predetermined quality rating.

At least one of said instant messaging steps may include the step of establishing the presence of the recipient of said message.

If the intended recipient is not present, the presence of a nominated delegate may be established and the instant messaging notification made to the delegate.

A notification to the delegate may be the original message. A notification to the delegate may be that the intended recipient is not present. The notification to the delegate may be made after an elapsed time.

In another aspect the invention provides a subscriber database for storing a record for subscribers, the record comprising the subscriber identity and one or more attributes associated with the subscriber, the subscriber database being associated with the notification of reports by instant messaging.

Said one or more attributes may include subject-matter of interest to the subscriber or authors of interest to the subscriber.

In general, the invention provides a technique for the provision of notifications on top of a database, the notifications being associated with information contained in or added to the database.

The invention further provides, in aspects, means adapted to perform any defined method step.

### BRIEF DESCRIPTION OF THE DRAWINGS

For a better understanding of the present invention and as to how the same may be carried into effect, reference will now be made by way of example to the accompanying drawings in which:

FIG. 1 illustrates an exemplary network environment;

FIG. 2 illustrates an exemplary client side network environment;

FIG. 3 illustrates an exemplary client side application architecture in accordance with an embodiment of the invention;

FIG. 4 illustrates an exemplary flow diagram illustrating an example implementation report preparation process in accordance with an embodiment of the present invention;

FIG. 5 illustrates an exemplary flow diagram illustrating an example implementation report purchase process in accordance with an embodiment of the present invention;

FIG. 6 illustrates an exemplary flow diagram illustrating an example implementation subscription process in accordance with an embodiment of the present invention;

FIG. 7 illustrates an exemplary flow diagram illustrating an example implementation publication process in accordance with an embodiment of the present invention;

FIG. 8 illustrates a further example network architecture for describing an embodiment of the invention;

FIG. 9 illustrates a signaling chart for the example of FIG. 8; and

FIG. 10 illustrates a flow chart for the example of FIG. 8.

### DESCRIPTION OF PREFERRED EMBODIMENTS

The present invention is described herein with reference to a particular illustrative embodiment. However, such embodiment is presented for the purposes of illustrating the present invention, and does not limit the scope thereof.

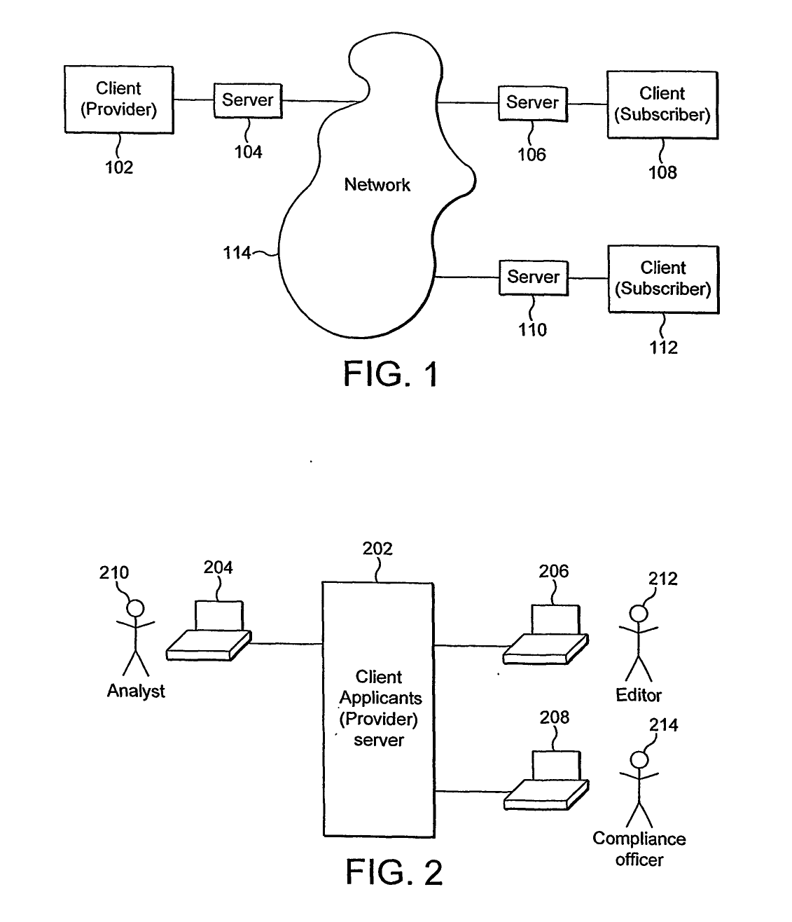

An overview of a typical computer network structure showing an interface between clients is illustrated with reference to FIG. 1.

All clients are associated with at least one server, and communication between clients is via the respective servers. FIG. 1 shows a client 102 which for the purposes of the described example is considered to be the provider of application services (‘provider client’), and particularly financial research information, to subscribers. Two clients 108 and 112 represent subscriber clients who have users associated therewith who subscribe to the services of the provider client 102. Each of the clients 102,108,112 is associated with and connected to a respective server 104,106,110. Each of the servers 104,106,110 is connected to a network 114, via which servers can communicate. The network may be any form of data network, including the Internet.

FIG. 2 illustrates an overview of the interconnection of users at the client provider side of FIG. 1. Client applications run on an applications server 202 at the provider side, which may or may not be the same server as the server 104 of FIG. 1. Various users are connected to the applications server 202. In FIG. 2 a computer terminal 204 associated with an analyst 210 is connected to the applications server 202, a computer terminal 206 associated with an editor 212 is connected to the applications server 202, and a computer terminal 208 associated with a compliance officer 214 is connected to the applications server 202.

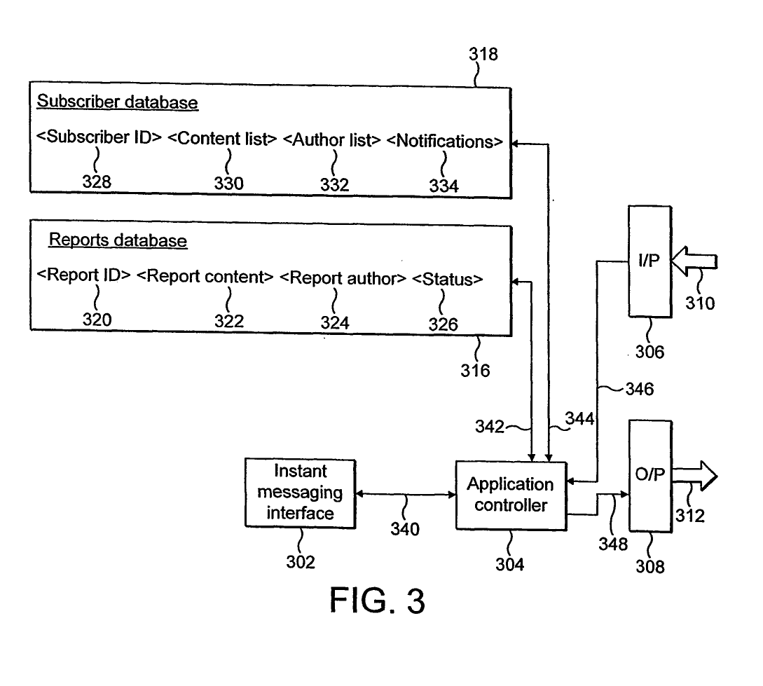

An embodiment of the preparation of a research report for publication is first described by way of an example implementation of the present invention. FIG. 3 illustrates in block diagram form an overview of the architecture for implementing client provider applications in accordance with such an embodiment of the present invention.

Referring to FIG. 3, an application controller 304 controls the implementation of the provider application services. Two primary databases are provided for supporting the provider services.

A reports database 316 provides a storage for information associated with reports. This may include a report identifier field 320 for uniquely identifying a report, a report content field 322 classifying or identifying the subject-matter included in the report, a report author field 324 identifying the analyst or researcher responsible for preparing the report, and a status field 326 identifying the current status of the report, e.g. “being edited”, “published”.

A subscriber database 318 provides a storage for information associated with subscribers who have subscribed to the provider client in order to receive reports. The subscriber database may include a subscriber identifier field 328 for uniquely identifying a subscriber, a content list field 330 for identifying the subject matter of interest to the subscriber, an author list field 332 for identifying the authors of interest to the subscriber, and a notifications field 334 for identifying the preferred notification options for the subscriber, e.g. e-mail addresses for e-mail notification, mobile phone numbers for short messaging service notification, etc.

The architecture further includes, in accordance with the preferred implementation of the present invention, an instant messaging interface 302, an input block 306 and an output block 308. The input block may receive messages and signaling on an input interface 310, and the output block may transmit messages and signaling on an output interface 312. As is discussed further hereinbelow, all the described embodiments of the present invention utilise instant messaging techniques, and hence the instant messaging interface 302 of FIG. 3 is provided, which may operate in combination with the input and output interfaces 306 and 308 to provide communications in the operation of applications, as described further hereinbelow.

Connections 344, 342, 340, 346, 348 are provided to respectively interface the application controller 304 to the subscriber database 318, the reports database 316, the instant messaging interface 302, the input block 306 and output block 308.

The arrangement of FIG. 3 is shown for illustrating the principles of an embodiment of the present invention. The elements shown are for the purposes of illustrating. the functionality of the embodiment of the present invention, and neither the embodiment nor the invention is limited to the specific elements shown.

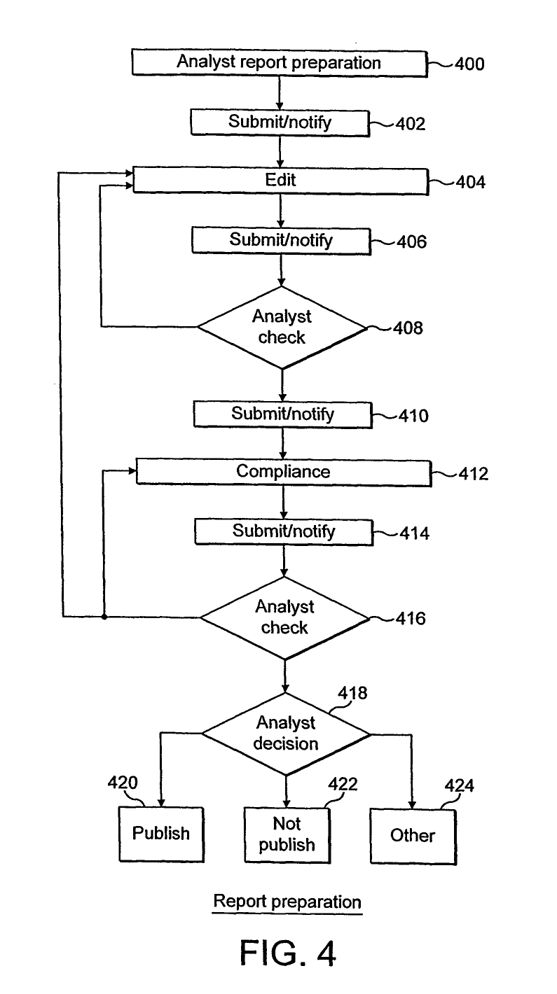

The embodiment of the preparation of a research report utilising the applications architecture of FIG. 3 is now described further with reference to the method steps of FIG. 4. In accordance with this embodiment of the present invention, a report application program is running on the client applications server 202.

In a first step 400 an analyst prepares a report relating to one or more issues, including one or more subject matter areas. A single issue may be associated with various different subject-matter. Preferably the analyst, accessing a report application program via terminal 204, is provided with a report template, which includes entry fields for the entry of subject-matter details.

In preparing the report, using the report application program, the application controller 304 preferably initiates an entry in the reports database 316 for the report. A unique identifier, such as the next available sequential number, is allocated to the report. The report identifier is included on the basis of the identity of the user of the report application program at the terminal, derived from log-on information. The status of the report gives an indication of ‘preparation in progress’ or such like.

On completion of the report, the analyst submits the report in which as further described below results in an instant notification to an editor or editors. Preferably this may be achieved by the analyst, accessing the report application program via terminal 204, selecting a submit option on a user interface.

Responsive to the activation of the submit option, the application controller 304 updates the details of the report in the reports database 316, and notifies the instant messaging interface. At this stage, the status field indicates that the report is awaiting editing.

Responsive to the updating of the status field, the instant messaging interface instantly messages a terminal 206 associated with an editor 212. In a preferred embodiment, all editors currently on-line may be instantly messaged.

The submission and notification are represented by submit/notify step 402 in FIG. 4.

On receipt of the instant message in a pop-up screen as known in the art, the editor is made aware of the report awaiting to be edited. Responsive thereto the editor, or one of a plurality of editors, selects an edit option from the report applications program user interface displayed on the editors computer terminal screen. In a step 404, the report is then edited. The application controller updates the status of the report in the report database to show the report as ‘being edited’, or such like.

On completion of the editing, the editor preferably selects a submit option from the user interface of the reports application program, and responsive thereto the application controller updates the status of the report in the reports database as ‘edited’, or such like.

In addition, in a step 406 the analyst is notified of the completion of the editing by instant messaging. The instant message to the analyst may be directly as result of the editor submitting the edited report, or may be as the result of an automated message response to the application controller 304 automatically sent on completion of editing. Thus the analyst is notified instantly of the completion of the editorial process.

The submission and notification are represented by submit/notify step 406 in FIG. 4.

Responsive to the instant message, the analyst preferably selects the edited report by selecting the appropriate option on the user interface. In a step 408, the analyst checks the report. This step is to ensure that the editorial process has not changed the meaning or substantive content of the report.

If the analyst determines that further changes to the report are necessary at this stage, whether because of the nature of the editing or otherwise, then the process may return to step 400 and a further editing step may take place. Again the completion of each step is notified to each party on the basis of instant messaging, and the report status in the reports database updated and maintained.

If in step 408 the analyst is satisfied with the result of the editorial process, then the analyst selects the appropriate option on the applications program user interface to submit the report for a compliance check.

As before, the status of the report is updated, and the compliance officer, or a group of compliance officers, is notified of the request for a compliance check by instant messaging.

The submission and notification are represented by submit/notify step 410 in FIG. 4.

The compliance check then takes place in a step 412. On receipt of the instant-messaging pop-up screen as known in the art, the compliance officer is made aware of the report awaiting to be checked. Responsive thereto the compliance officer, or one of a plurality of compliance officers, selects a compliance option from the report applications program user interface displayed on the compliance officers computer terminal screen. In the step 412, the report is then checked for compliance. The application controller updates the status of the report in the report database to show the report as being ‘checked for compliance’ or such like.

On completion of the compliance checking, the compliance officer preferably selects a submit option from the user interface of the reports application program, and responsive thereto the application controller updates the status of the report in the reports database as ‘compliance checked’.

In addition, the analyst is notified of the completion of the compliance checking by instant messaging. The instant message to the analyst may be directly as result of the compliance officer submitting the compliance-checked report, or maybe as the result of an automated message response to the application controller 304 automatically sent on completion of compliance checking. Thus the analyst is notified immediately of the completion of the compliance process.

The submission and notification are represented by submit/notify step 414 in FIG. 4.

Responsive to the instant message, the analyst selects the compliance checked report by selecting the appropriate option on the user interface. In a step 408, the analyst checks the report. This step is to ensure that the compliance process has not changed the meaning or substantive content of the report.

If the analyst determines that further changes to the report are necessary at this stage, whether because of the nature of the changes for compliance or otherwise, then the process may return to either step 404 or step 412 and further editing or compliance steps may take place. Again the completion of each step is notified to each party on the basis of instant messaging, and the report status in the reports database maintained.

If in step 418 the analyst is satisfied with the result of compliance process, then in a step 418 the analyst selects an appropriate option on the applications program user interface to further utilise the report and determine a next step.

In a step 420, and as further discussed hereinbelow, the analyst may choose for the report to be published. In a step 422, the analyst may choose not to publish, for example because the information is no longer current. In a step 424 the analyst may choose some other action, such as to defer publication (e.g. until a specified time/date).

The status of the report is updated, and maintained at all stages of the process, such that the reports database always shows the current status of the report.

The above-described embodiment may be further adapted to utilize presence information. For example, in step 404 or step 412 of FIG. 4 there may be no editor or compliance officer available. Automated presence services may notify the analyst after steps 406 or 414, for example, if the presence server is aware that no editor or compliance officer is present. Similarly, if the document is ready for publishing, or ready after editing or compliance checking, presence services may be utilized to detect the presence of the analyst. If the analyst is not present, the presence services may be adapted to notify the analyst's team leader or other authorized delegate.

Thus, in accordance with the invention, instant messaging provides a technical solution to enable the preparation of analyst or research reports to be prepared much more quickly compared to techniques known in the art. For the process of the preparation of such reports, which are time critical, the invention is significantly advantageous. Electronic transmission of messages, and in particular the automated transmission of messages responsive to completion of tasks, provides a significantly enhanced technical infrastructure and network for use in the preparation and dissemination of a report, and more generally a workflow.

The use of the subscriber and reports databases 318 and 316 further allow reports to be aggregated. For example it may be known that a particular client is interested in any report including certain subject-matter, which details are stored in the subscriber database, and at a particular time all reports containing such subject-matter, identified from the subscriber database 318, may be merged and transmitted to the subscriber. A subscriber may choose, for example, to receive all relevant reports at a certain time—or certain time intervals—each day.

It should be noted that FIG. 3 illustrates one possible embodiment for implementing the principles of the present invention. In alternative arrangements, for example, and with reference to FIG. 1, the reports database may be provided with the application server on the provider side, whilst the subscriber database, or elements thereof, may be provided on subscriber side. More specifically each subscriber client 108 or 112 of FIG. 1 may have a subscriber database associated therewith. In such an arrangement, completed reports may be provided from the provider side to the subscriber side, the subscriber side distributing the report to its own subscribers utilising its own subscriber database. Thus a plurality of subscriber applications at various locations may be associated with various organisations each associated with a respective subscriber database.

The subscriber database is used to disseminate reports. On completion of a report, and responsive to a decision to publish, a comparison is made between the report author field 324 and the author list field 332, and/or a comparison is made between the report content field 322 and the content list 330. Responsive to any match, the subscriber identified in the subscriber ID field 328 of the subscriber database 318 is notified of the report or receives the report by instant messaging or other notification technique as identified in the notifications field 334.

Where the subscriber database is located at the client subscriber side, responsive to the publication command the report is sent to the client subscriber (preferably using instant messaging) at which client subscriber the report is distributed amongst subscribers or registered users as appropriate. In such an arrangement the provider client may still be provided with a ‘master’ subscriber database, identifying the main client subscribers, such as client subscribers 108 and 112 in FIG. 1, to which the report should be distributed. Such ‘master’ subscriber database at the provider application may be termed a distribution database.

Where the subscriber database is provided at the subscriber side, there may further be provided means for altering the presentation of the report. For example the report may be presented in an alternative style.

The example described hereinabove with reference to FIG. 4 relates specifically to the advantageous use of instant messaging techniques in the preparation and notification of reports, specifically at the analyst side in financial research.

In the financial services industry, ‘buy-side’ and ‘sell-side’ are standard terms, respectively for the fund management and the brokerage sections. More generally either the ‘buy-side’ or the ‘sell-side’ can be considered to be a ‘trade-side’.

The technical advantages of the present invention can be obtained by application at the buy-side or the trade side. The invention will allow buy-side clients to trade financial instruments or products associated with the report.

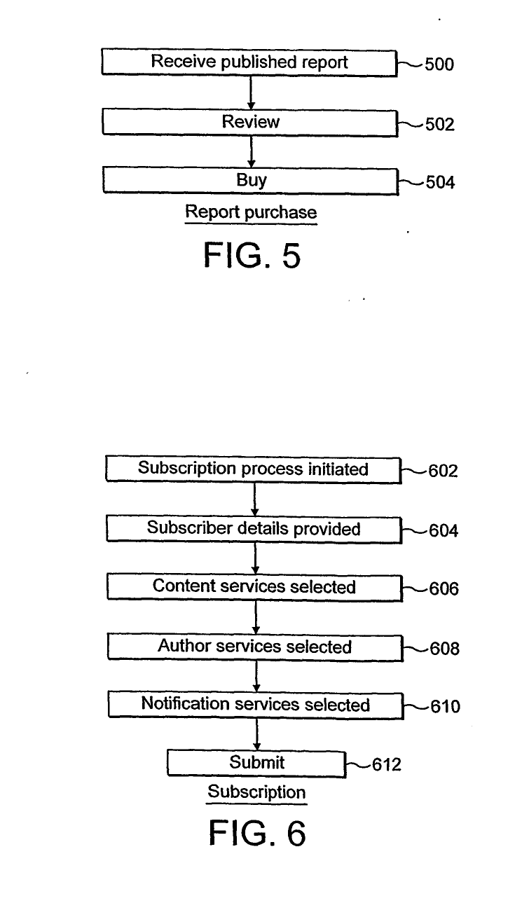

Referring to FIG. 5, at the client subscriber side there may be received in a step 500 a published report in an instant messaging action. The client then reads the report in a step 502. The instant messaging notification may include a link to where the report can be found, rather than the actual report itself.

Preferably, in accordance with an embodiment of the invention, the report includes an option to perform an action, e.g. an option to trade a financial instrument associated with the report. The action can be selected by the client after reading the report, in order to purchase a financial product or products which is the subject of the report. This is represented by step 504.

In accordance with this embodiment of the invention the selection of a buy (or sell) option by the client results in an instant message notification to a broker associated with the research analyst who prepared the report, and as such the selected action is processed instantly on the basis of instant messaging techniques. This provides an instant trade option, such as buy-back, for the client.

The reports database and the subscriber database 316 and 318 may be further adapted to allow fields to be entered to monitor trading activity, such that an audit trail is stored showing not only the process—including time-stamps—in the preparation of the report, and the distribution of the report, but also trading activity based on the circulation of the report.

The trade process preferably incorporates digital signature techniques to provide an instant secure trading process. Preferably clients are provided with application program interfaces to enable them to access the system.

The application of instant messaging in the preparation of financial reports as discussed hereinabove may be further utilized to further improve procedures. For example, instant-messaging techniques may be used by one person in the report preparation to see if another person involved in the report preparation is logged in and available.

The applications programs required to implement the techniques described herein, and specifically the application of instant messaging to report preparation, are preferably run on a server such as the client applications provider 202 of FIG. 2 appropriately adapted, or may be provided on a dedicated server.

It is proposed in a preferred embodiment to implement the application software necessary to support the techniques described herein utilizing the existing servers utilized by financial organizations for internal communications and transactions.

More particularly, the application software is preferably provided on an extensible Messaging and Presence Protocol (XMPP) platform. XMPP has the ability to handle complex messages, such as those containing a textual notification together with data (e.g. the author of the report, the title of the report, current status etc.) and actions (e.g. “update status to complianced” or “submit purchase request for this equity”).

The preferred embodiment for the messages, data and actions is extensible Mark-up Language (XML). XML may be used in the form associated with the particular industry with which a managed workflow is associated. For example RIXML(Research Information Exchange Markup Language) may be used in financial research applications, XBRL(Extensible Business Reporting Language) may be used in company accounting applications, and FIXML(Financial Information Exchange Markup Language) may be used in purchasing request applications. The present invention utilizes instant messaging, in embodiments, to allow different applications to communicate directly with each other. As such, databases in different systems, e.g. provider and subscriber databases, can effectively communicate directly with each other via instant messaging.

A further example of the use of instant messaging in the provision of financial services is the exploitation of the direct communication between different databases. For example, a user may obtain a quote directly from a plurality of databases by instant messaging, and the application software associated with the client may compare the instant messaging replies and select the cheapest, and place an order by instant messaging.

The use of instant messaging may be used to discuss reports and documents in a dynamic way. For example, in the example above, when a subscriber client receives notification of a received report, other subscribers may similarly receive the report. The report may include a ‘discuss’ option which enables the subscriber to submit a comment, which comment is instantly notified to other subscribers. The subscribers may be common to a network, or may be associated with different networks. A subscriber may select the other subscribers or users to which the comments are to be notified, thus creating an instant discussion group. Further such discussion may be logged in a database in the network, for further use or for further users to access. The discussion may be linked to a specific research report in the database.

In this way, various people's comments are captured, and a database of institutional knowledge is compiled. The database may thus automatically escalate the content of the report or information associated with’ the report. A document may become more important on the basis of comments appended thereto or included therein.

The use of instant messaging in accordance with various embodiments of the present invention provides for presence services to determine if a particular user or subscriber is present, instant notification of an occurrence, and an instant communication medium.

The use of presence may be exploited by a database storing a subscriber details, such that a report is only sent to a subscriber when the database detects the subscribers presence through instant messaging. A database may trigger an instant message to a subscriber who has, for example, registered an interest in a particular piece of research, and a new comment on that research has been added to the database.

Advantageously, presence services can be utilized to ensure that a report is processed quickly. If presence services indicate that the intended recipient of an instant message is not available, then an appropriate delegate may be notified by proxy, such delegate being determined by presence services to be available.

The system may utilize presence services to detect if the intended recipient of the instant message notification is online. If they are not, then the system database is preferably adapted for each user to list suggested delegates when a user is not available, and the system uses the presence services to check their availability, and notifies the appropriate delegate by instant messaging. In one embodiment, the delegate is the superior or manager to the intended recipient, and in this way presence services are used to escalate the report. Alternatively the system may simply notify the delegate that the person to whom a message was intended to be sent is unavailable.

The attempt to notify a delegate may happen immediately or after a certain time has elapsed without the presence of the intended recipient being detected.

Another example of the use of presence services is in the preparation of the analyst report as described hereinabove. For example, on checking the report a compliance officer identifies an issue and returns the report to the analyst. Thereafter, the analyst modifies the report and resubmits it for compliance. Ideally, the report should be checked by the same compliance officer again. However, if presence services indicate that compliance officer is not currently available, then the system may notify a delegate by instant messaging instead, to ensure the report is prepared without delay.

The use of instant messaging between databases can be used to keep the contents of databases up to date and consistent in an automated manner.

Although the present invention is described herein by way of exemplary embodiments in the field of financial services, the invention is more broadly applicable. In general, the invention relates to the distribution or notification of information, such as reports or comments, utilizing instant messaging techniques.

Referring to FIG. 6 there is illustrated an example implementation of a process for subscribing to a service in accordance with a preferred embodiment of the invention.

In a step 602, a subscription process is initiated, for example through a website associated with an application provider. In a step 604, the details of the subscriber are provided to the application service, such as payment details.

In a step 606 the subscriber indicates the content services of interest, i.e. the subject matter of interest to the subscriber. In a step 608 the subscriber indicates the author services of interest, i.e. the authors whose reports the subscriber is interested in receiving. In a step 610 the subscriber indicates the notifications services of interest; in embodiments information may further be notified to subscribers by short messaging service (SMS) or e-mail, for example, or by virtue of more than one instant messaging service.

Finally in a step 612 a subscriber submits the full details to the application server.

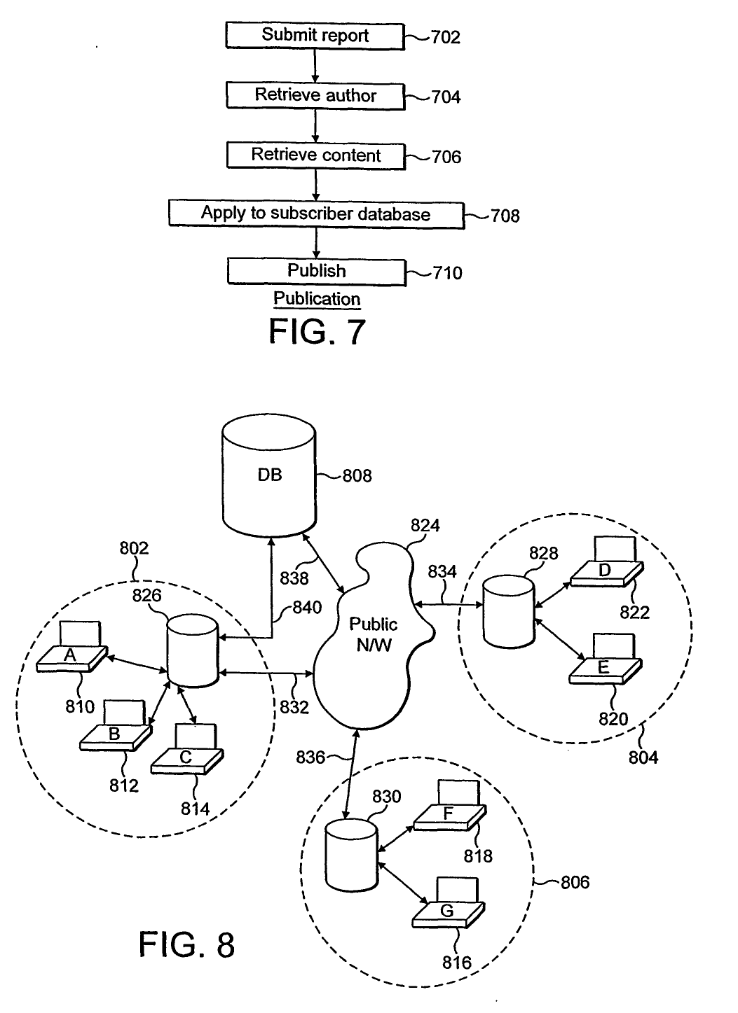

Referring to FIG. 7, there is illustrated the steps in making available a report for publication in accordance with an embodiment of the invention. In a step 702 the report is submitted, preferably through a website portal or other template, to the application server.

The application software retrieves the identity of the report author in a step 704, and the content (subject-matter types) of the report in a step 706. These fields are preferably specifically entered in the report by the author.

In a step 708 the application software preferably applies these fields, i.e. stores them, in a reports database, together with an identification of the report. In a step 710 the report is then ‘published’, preferably by instant messaging notification of the report.

The general concept of instant report publishing in accordance with an embodiment of the invention is further illustrated with reference to an example described with reference to FIGS. 8 to 10.

Referring to FIG. 8, there is illustrated three private or restricted access networks 802, 804 and 806. A database DB 808 stores details of reports and subscribers, and is associated with an application provider. Each of the networks 802, 804 and 806 has users who are subscribers to the application provider associated with database DB 808. The network 802 has subscriber A 810, subscriber B 812, and subscriber C 814, the network 804 has subscriber D 822, and subscriber E 820, and the network 806 has subscriber F 818, and subscriber. G 816. The subscribers of each network 802, 804 and 806 interface with a public network 824 via a connection to a respective server 826, 828 and 830, each of which has a respective connection 832, 834 and 836 to the public network 824.

The database DB 808 is connected to the public network 824 via a communication line 838. In addition, the network 802 has a direct connection 840 to the database DB 808, the database DB 808 being associated with the private network 802.

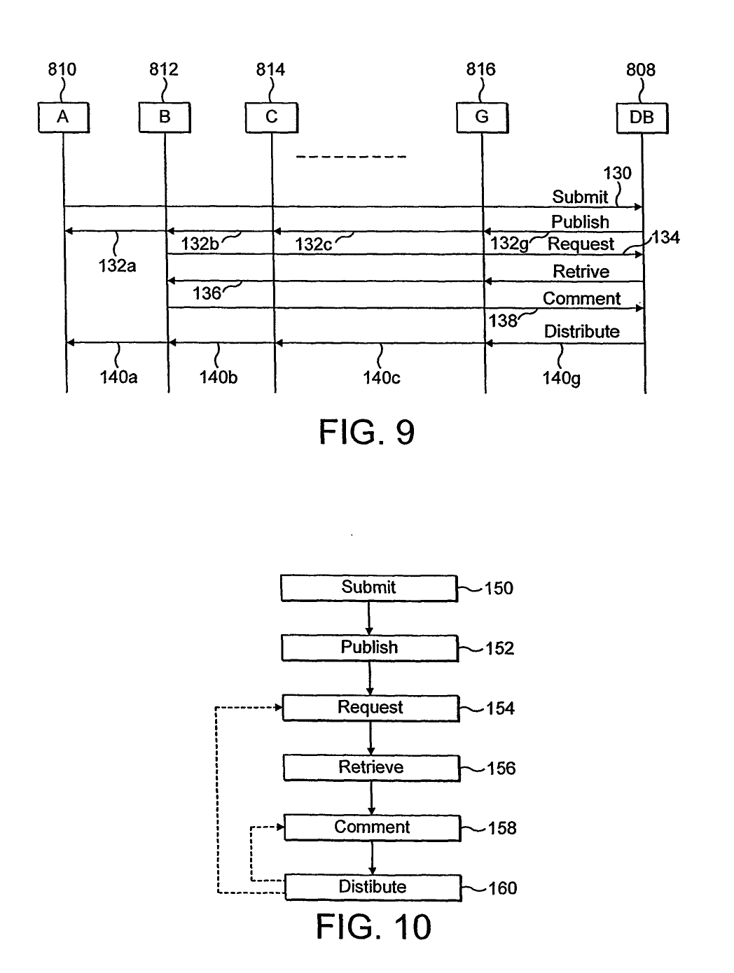

For the purpose of the present example, it is assumed that subscriber A 810 is the author of a report. The example is described further with reference to the signaling chart of FIG. 9 and the flow chart of FIG. 10.

In a step 150, the author submits the report to be published to the database DB 808 with an instant messaging session SUBMIT, as identified by signal 130 in FIG. 9. It will be appreciated that the SUBMIT step 150 may correspond to the PUBLISH step 420 of FIG. 4 described above. Responsive to the SUBMIT step 150 the database DB 808 is updated to store the report and any associated attributes.

On storing the report, the database DB 808 assesses the associated attributes to determine the publication or circulation list for the report. In a step 152 the report is published by means of a plurality of instant messaging sessions PUBLISH to each of the subscribers, as represented by signaling messages 132a to 132g in FIG. 9. In this preferred embodiment, the author of the report is also notified of publication.

In a step 154 the subscriber B 812 accesses the published report with an instant messaging session REQUEST to the database DB 808, as represented by signaling message 134 in FIG. 9.

Responsive thereto, the database DB 808 provides the report with an instant messaging session RETRIEVE to the subscriber B 812, as represented by the signaling message 136, in a step 156. This example makes the assumption that the publication of the report is a notification of publication, and not a distribution of the report itself. This limits the circulation of the report specifically to those users that request it, which saves network bandwidth.

In a step 158, the subscriber B 812 comments on the report with an instant messaging session COMMENT to the database DB 808, as represented by the signaling message 138.

Responsive thereto the database DB 808 updates its contents, and then in a step 160 notifies all subscribers of the existence of the new comments with an instant messaging session DISTRIBUTE to all subscribers, as represented by the signaling 140a to 140g in FIG. 9.

Further subscribers may retrieve the report and/or comments in step 154, and further subscribers may make comments in step 158.

Thus a report is distributed. The same principles apply to the preparation of a report in a workflow, where the comments may be considered to be amendments to the report.

The discussions associated with a given report may not be generally public, or not available to users of all networks. The comment loop for a given report may be confined to within a specific organization. Thus in the arrangement of FIG. 8, the subscriber's network 802 may be provided with a reports database for that network. All commenting within that network is stored on the associated reports database, and such comments are only available within that network. In a financial application a decision to trade, i.e. buy or sell, may then be based on the comments exchanged within that network.

It will be understood, therefore, that use of the term ‘publish’ herein is intended to convey some distribution of a report, but such distribution may be a private distribution rather than a public distribution.

Within a given network any comments may include a rating for the quality of the report. Certain subscribers of a network may implement filters such that reports on subject-matter of interest may only be notified to them if they are given a high rating, or if another ‘trusted’ subscriber marks the report as interesting or of high value.

Thus, and referring again to FIG. 8, in an alternative embodiment after the report is created in network 802, the network 802 may distribute the report to servers 828 and 830 of networks 804 and 806. As such, the servers 828 and 830 are considered subscribers from the perspective of the network 802. The network 802 may include a subscriber database which identifies only other networks, in this example the networks 804 and 806.

A subscriber network, such as network 804, may then enter the report into a reports database for that network. The report may then be circulated, or its existence notified, to subscribers of that network which are identified in a subscriber database for that network. Thus the server 828 may notify users associated with terminals 822 and 820 of the existence of the report, in accordance with the various attributes of the report and the various attributes of the subscribers stored in the subscriber database. A discussion of the report may then take place within the network 804, confined to such network. A trade, i.e. a buy or sell, may subsequently take place between a subscriber in the network 806 and a user in the network 802 (i.e. the network of the organization originating the report).

The present invention provides an application of instant messaging techniques to allow management of workflow and/or the distribution of content, and is not limited to any specific field, e.g. financial services, of application. The specific examples relating to financial services are given herein for the purposes of illustrating the present invention.

For example, the principles of the present invention may be utilized in legal services and auctions. In automated auctions such as on-line auctions, the invention may provide for notifications on the back of events, with messages containing information which can be used to bid in the auction. A user may subscribe to an auction service, identifying a product of interest, and receive an instant notification when such a product becomes available in an auction. Similar uses of the invention may be used in business-to-business processes, which are effectively commercial level auction processes. An example of such business-to-business processes is bidding for selling/buying steel. The principles of the present invention may also be utilized in handling settlement of any purchase.

Further applications of the present invention may be found in gaming notifications, in particular on-line gaming such as simulation games. The principles of the present invention may be utilized to notify when an action is needed, with a character taking part in a game even when the user is not logged in. An event involving a game character may result in an instant message to the user advising of a situation in which the user's game character needs to take action.

The present invention is described herein with reference to examples of preferred embodiments for the purpose of illustration, and is not limited to any such embodiments. The scope of the present invention is defined by the appended claims.

1. A method of monitoring a database, comprising notifying a database subscriber by instant messaging when an entry in the database is altered.

2. A method according to claim 1, wherein a database entry is altered by addition of a new database entry.

3. A method according to claim 1, wherein a database entry is altered by amendment of an existing database entry.

4. A method according to claim 1, wherein a database entry is altered by deletion of an existing database entry.

5. A method according to claim 1 wherein said database is an auction database, said subscriber being an auction bidder, and said alteration of a database entry being the addition to an auction of an item of interest to the auction bidder.

6. A method according to claim 1 wherein said database is an electronic games database comprising a plurality of entries associated with a game, said subscriber being a player of said game, and said alteration of a database entry being an action in said game which affects the player.

7. A method according to claim 6 wherein the game is a character-based game, said player being associated with a character in the game, the action being an occurrence associated with said character.

8. A method according to claim 7 wherein said game is an on-line interactive game.

9. A method according to claim 1, further comprising the step of determining whether the subscriber is present to receive said message.

10. A method according to claim 9 wherein if the subscriber is not present, a nominated delegate is notified by instant messaging.

11. A method according to claim 10, further comprising the step of determining the presence of the delegate, wherein the delegate is notified if present.

12. A computer system adapted for monitoring a database, comprising means for notifying a database subscriber by instant messaging when an entry in the database is altered.

13. A computer system according to claim 12, comprising means for altering a database entry by addition of a new database entry.

14. A computer system according to claim 12, comprising means for altering a database entry by amendment of an existing database entry.

15. A computer system according to claim 12, comprising means for altering a database entry by deletion of an existing database entry.

16. A computer system according to claim 12 wherein said database is an auction database, said subscriber being an auction bidder, wherein the computer system comprises means for alteration of a database entry by the addition to an auction of an item of interest to the auction bidder.

17. A computer system according to claim 12 wherein said database is an electronic games database comprising a plurality of entries associated with a game, said subscriber being a player of said game, wherein the computer system comprises means for alteration of a database entry based on an action in said game which affects the player.

18. A computer system according to claim 17 wherein the game is a character-based game, said player being associated with a character in the game, the action being an occurrence associated with said character.

19. A computer system according to claim 18 wherein said game is an on-line interactive game.

20. A computer system according to claim 12, further comprising presence means for determining whether the subscriber is present to receive said message.

21. A computer system according to claim 20 further comprising means, responsive to the subscriber not being present, for notifying a nominated delegate by instant messaging.

22. A computer system according to claim 21, further comprising means for determining the presence of the delegate, and means for notifying the delegate if present.

23. A method of processing a workflow comprising a plurality of tasks, in which completion of at least one task is notified by instant messaging.

24. A method according to claim 23 wherein the notification is to an owner of a subsequent task.

25. A method according to claim 23 or claim 24 further comprising storing an identity associated with said workflow in a database.

26. A method according to claim 25 wherein said database stores the identity of a plurality of workflows.

27. A method according to claim 25 further comprising the step of storing a status associated with the current state of the workflow.

28. A method according to claim 27 wherein the status is updated responsive to the notification by instant messaging of a task associated with the workflow.

29. A method according to claim 28 wherein the updating of the status is notified by instant messaging.

30. A method according to claim 23, in which completion of at least one task is notified by a plurality of messages utilising instant messaging.

31. A method according to claim 30 wherein there is associated a plurality of users with said workflow, each message being associated with one of said users.

32. A method according to claim 31 wherein each task is completed by one of said users.

33. A method according to claim 32 wherein at least one task is determined by a user.

34. A method according to claim 33 wherein at least one task is the preparation of a document, and at least one further task is a preparation of a comment on a document.

35. A method according to claim 34 wherein the workflow is the preparation of a report.

36. A method according to claim 23 further comprising determining the presence of a recipient of said instant messaging.

37. A method according to claim 36, wherein is said recipient is not present, the instant messaging is directed to a nominated delegate.

38. A computer system adapted to process a workflow comprising a plurality of tasks, in which completion of at least one task is notified by instant messaging.

39. A computer system according to claim 38 including means adapted to notify an owner of a subsequent task.

40. A computer system according to claim 38 including means for storing an identity associated with said workflow in a database.

41. A computer system according to claim 40 wherein said database is adapted to store the identity of a plurality of workflows.

42. A computer system according to claim 40 including means for storing a status associated with the current state of the workflow.

43. A computer system according to claim 42 including means adapted to update the status responsive to the notification by instant messaging of a task associated with the workflow.

44. A computer system according to claim 43 including means for notifying updating of the status by instant messaging.

45. A computer system according to claim 38, including means for, responsive to completion of at least one task, for transmitting a plurality of messages utilising instant messaging.

46. A computer system according to claim 45 wherein there is associated a plurality of users with said workflow, each message being associated with one of said users.

47. A computer system according to claim 46 wherein each task is completed by one of said users.

48. A computer system according to claim 47 wherein at least one task is determined by a user.

49. A computer system according to claim 48 wherein at least one task is the preparation of a document, and at least one further task is a preparation of a comment on a document.

50. A computer system according to claim 38 wherein the workflow is the preparation of a report.

51. A computer system according to claim 38 further comprising means for determining the presence of a recipient of said instant messaging.

52. A computer system according to claim 51, wherein if said recipient is not present, the means is adapted to direct instant messaging to a nominated delegate.

53. A method of compiling a financial report, comprising the steps of:
a. preparing a report;
b. notifying preparation of the report by instant messaging;
c. responsive to said instant messaging notification, editing the report;
d. notifying editing of the report by instant messaging;
e. responsive to said instant messaging notification, checking the report for regulatory compliance;
f. notifying completion of the check for compliance by instant messaging; and
g. responsive to said instant messaging notification the report is completed.

54. A method according to claim 53 wherein there is further provided a step of storing attributes of the report.

55. A method according to claim 54 wherein there is provided a reports database comprising a plurality of entries each corresponding to one of a plurality of reports, each entry including the attributes for the respective report.

56. A method according to claim 55 wherein the attributes include a current status of the report.

57. A method according to claim 55 wherein the attributes include an identifier representing the author of the report.

58. A method according to claim 55 wherein the attributes include at least one identifier representing subject-matter associated with the report.

59. A method according to claim 55 wherein the attributes include a unique identifier for the report.

60. A method according to claim 53, further comprising the step of repeating the preparing step after the editing step.

61. A method according to claim 53, further comprising the step of repeating the preparing step after the compliance step.

62. A method according to claim 53, further comprising the step of repeating the editing step after the compliance step.

63. A method according to claim 53, wherein responsive to completion of the report the report is published.

64. A method according to claim 63 wherein the report is published by instant messaging notification.

65. A method according to claim 63 wherein said publication is within a defined group.

66. A method according to claim 65 wherein publication is to a subscriber list.

67. A method according to claim 66 wherein the subscriber list is stored in a subscriber database.

68. A method according to claim 67 wherein the subscriber database stores a record for each subscriber.

69. A method according to claim 68 wherein the record comprises the subscriber identity and one or more attributes associated with the subscriber.

70. A method according to claim 69 wherein said one or more attributes includes subject-matter of interest to the subscriber.

71. A method according to claim 69 wherein said one or more attributes includes report authors of interest to the subscriber.

72. A method according to claim 69 wherein the publication of the report to a subscriber is dependent upon the report being associated with one or more attributes of the said subscriber.

73. A method according to claim 66 wherein responsive to the instant messaging notification, the report is reviewed by one or more subscribers.

74. A method according to claim 66 wherein responsive to the instant messaging notification, the report is accessed by one or more subscribers.

75. A method according to claim 74, further comprising the step of requesting a financial transaction associated with the report.

76. A method according to claim 75 wherein said request is by instant messaging.

77. A method according to claim 76 wherein the instant message is received by a broker associated with the report author.

78. A method according to claim 63 further comprising the step of any one of the plurality of subscribers commenting on the report, wherein the comments are notified to at least some of the subscribers by instant messaging.

79. A method according to claim 53 wherein status of the report is stored in a database.

80. A method according to claim 53 wherein the instant messaging notification utilizes presence services.

81. A method according to claim 55 wherein the report attributes include a comment made by a report reviewer.

82. A method according to claim 81 wherein the publication of the report to a subscriber is dependent on the report record including a comment from a predetermined report reviewer.

83. A method according to claim 82 wherein the attributes comprise a plurality of said comments from a plurality of reviewers.

84. A method according to claim 82 wherein a comment is entered into the report record responsive to an instant messaging notification from the reviewer.

85. A method according to claim 82 wherein the attributes include a quality rating provided by a report reviewer.

86. A method according to claim 82 wherein the publication of the report to a subscriber’ is dependent on the report record including a predetermined quality rating.

87. A method according to claim 53 wherein at least one of said instant messaging steps includes the step of establishing the presence of the recipient of said message.

88. A method according to claim 87 wherein if the intended recipient is not present, the presence of a nominated delegate is established and the instant messaging notification made to the delegate.

89. A method according to claim 88 wherein a notification to the delegate is the original message.

90. A method according to claim 88 wherein a notification to the delegate is that the intended recipient is not present.

91. A method according to claim 88 wherein the notification to the delegate is made after an elapsed time.

92. A computer system adapted for compiling a financial report, comprising: means for notifying preparation of the report by instant messaging; means for notifying editing of the report by instant messaging; and means for notifying completion of the check for compliance by instant messaging.

93. A computer system according to claim 92 wherein there is further provided means for storing attributes of the report.

94. A computer system according to claim 93 wherein there is provided a reports database comprising a plurality of entries each corresponding to one of a plurality of reports, each entry including the attributes for the respective report.

95. A computer system according to claim 94 wherein the attributes include a current status of the report.

96. A computer system according to claim 94 wherein the attributes include an identifier representing the author of the report.

97. A computer system according to claim 94 wherein the attributes include at least one identifier representing subject-matter associated with the report.

98. A computer system according to claim 94 wherein the attributes include a unique identifier for the report.

99. A computer system according to claim 92, wherein further comprising publishing the report.

100. A computer system according to claim 99 comprising means adapted to publish the report by instant messaging notification.

101. A computer system according to claim 99 wherein publication is to a subscriber list.

102. A computer system according to claim 101 wherein the subscriber list is stored in a subscriber database.

103. A computer system according to claim 102 wherein the subscriber database stores a record for each subscriber.

104. A computer system according to claim 103 wherein the record comprises the subscriber identity and one or more attributes associated with the subscriber.

105. A method according to claim 104 wherein said one or more attributes includes subject-matter of interest to the subscriber.

106. A method according to claim 104 wherein said one or more attributes includes report authors of interest to the subscriber.

107. A method according to claim 104 wherein the publication of the report to a subscriber is dependent upon the report being associated with one or more attributes of the said subscriber.

108. A method according to claim 101 wherein responsive to the instant messaging notification, the report is reviewed by one or more subscribers.

109. A method according to claim 101 wherein responsive to the instant messaging notification, the report is accessed by one or more subscribers.

110. A method according to claim 109, further comprising the step of requesting a financial transaction associated with the report.

111. A method according to claim 109 wherein said request is by instant messaging.

112. A method according to claim 111 wherein the instant message is received by a broker associated with the report author.

113. A method according to claim 108 further comprising the step of any one of the plurality of subscribers commenting on the report, wherein the comments are notified to at least some of the subscribers by instant messaging.

114. A method according to claim 92 wherein status of the report is stored in a database.

115. A method according to claim 92 wherein the instant messaging notification utilizes presence services.

116. A method according to claim 104 wherein the report attributes include a comment made by a report reviewer.

117. A method according to claim 113 wherein the publication of the report to a subscriber is dependent on the report record including a comment from a predetermined report reviewer.

118. A method according to claim 117 wherein the attributes comprise a plurality of said comments from a plurality of reviewers.

119. A method according to claim 118 wherein a comment is entered into the report record responsive to an instant messaging notification from the reviewer.

120. A method according to claim 119 wherein the attributes include a quality rating provided by a report reviewer.

121. A method according to claim 118 wherein the publication of the report to a subscriber is dependent on the report record including a predetermined quality rating.

122. A method according to claim 92 wherein at least one of said instant messaging steps includes the step of establishing the presence of the recipient of said message.

123. A method according to claim 122 wherein if the intended recipient is not present, the presence of a nominated delegate is established and the instant messaging notification made to the delegate.

124. A method according to claim 123 wherein a notification to the delegate is the original message.

125. A method according to claim 123 wherein a notification to the delegate is that the intended recipient is not present.

126. A method according to claim 123 wherein the notification to the delegate is made after an elapsed time.

127. A subscriber database for storing a record for subscribers, the record comprising the subscriber identity and one or more attributes associated with the subscriber, the subscriber database being associated with the notification of reports by instant messaging.

128. A subscriber database according to claim 127 wherein said one or more attributes includes subject-matter of interest to the subscriber.

129. A subscriber database according to claim 129 wherein said one or more attributes includes report authors of interest to the subscriber.
